(19) United States
(12) Patent Application Publication
(10) Pub. No.: US 2010/0217952 A1
(43) Pub. Date: Aug. 26, 2010

(54) Remapping of Data Addresses for a Large Capacity Victim Cache

(76) Inventors: Rahul N. Iyer, Sunnyvale, CA (US); Garth R. Goodson, Fremont, CA (US)

Correspondence Address: Stattler-Suh PC, 60 SOUTH MARKET, SUITE 480, SAN JOSE, CA, 95113, US

(21) Appl. No.: 12/393,958

(22) Filed: Feb. 26, 2009

(51) Int. Cl. G06F 12/06

(52) U.S. Cl. 711/209; 711/E12.078

(57) ABSTRACT

Method and apparatus for remapping addresses for a victim cache used in a storage system is provided. The storage system may store data blocks having associated storage system addresses. Blocks may be stored to a main cache and blocks evicted from main cache may be stored in the victim cache, each evicted block having a storage system address and a victim cache address where it is stored in the victim cache. Remapping data for remapping between storage system addresses to victim cache addresses may be stored in remapping data structures. The victim cache may be sub-divided into two or more sub-sections, each sub-section having an associated remapping data structure for storing its remapping data. By sub-dividing the victim cache, the bit size of victim cache addresses stored in the remapping data structures may be reduced, thus reducing the overall storage size of the remapping data for the victim cache.

### FIELD OF THE INVENTION

The present invention relates to storage systems, and particularly, to remapping of data addresses for a large capacity victim cache.

### BACKGROUND OF THE INVENTION

A storage system is a processing system adapted to store and retrieve data on storage devices (such as disks). The storage system includes a storage operating system that implements a file system to logically organize the data as a hierarchical structure of directories and files on the storage devices. Each file may be implemented as a set of blocks configured to store data (such as text), whereas each directory may be implemented as a specially-formatted file in which data about other files and directories are stored. The storage operating system may assign/associate a unique storage system address (e.g., logical block number (LBN)) for each data block stored in the storage system.

The storage operating system generally refers to the computer-executable code operable on a storage system that manages data access and access requests (read or write requests requiring input/output operations) and may implement file system semantics in implementations involving storage systems. In this sense, the Data ONTAP® storage operating system, available from NetApp, Inc. of Sunnyvale, Calif., which implements a Write Anywhere File Layout (WAFL®) file system, is an example of such a storage operating system implemented as a microkernel within an overall protocol stack and associated storage. The storage operating system can also be implemented as an application program operating over a general-purpose operating system, such as UNIX® or Windows®, or as a general-purpose operating system with configurable functionality, which is configured for storage applications as described herein.

A storage system's storage is typically implemented as one or more storage volumes that comprise physical storage devices, defining an overall logical arrangement of storage space. Available storage system implementations can serve a large number of discrete volumes. A storage volume is “loaded” in the storage system by copying the logical organization of the volume's files, data, and directories, into the storage system's memory. Once a volume has been loaded in memory, the volume may be “mounted” by one or more users, applications, devices, and the like, that are permitted to access its contents and navigate its namespace.

A storage system may be configured to allow client systems to access its contents, for example, to read or write data to the storage system. A client system may execute an application that “connects” to the storage system over a computer network, such as a shared local area network (LAN), wide area network (WAN), or virtual private network (VPN) implemented over a public network such as the Internet. The application executing on the client system may send an access request (read or write request) to the storage system for accessing particular data stored on the storage system.

The storage system may typically implement disk devices for storing data. For improved response to received read or write requests, the storage system may also temporarily store/cache particular data in a buffer cache (“main cache”) in storage system memory for faster access. The storage system may employ caching algorithms to determine which data to store in the main cache (e.g., such as algorithms that predict which data is likely to be requested by future client requests). Since the storage size of the main cache is relatively small, data stored in the main cache must routinely be transferred (“evicted”) out of the main cache to make space for new data. Data transferred out of the main cache (referred to as “evicted data”) may be stored to a victim cache.

The victim cache may comprise a memory device having lower random read-latency than a disk device and may thus still provide faster data access than disk devices. The victim cache may also comprise a storage device that is less costly (for a given amount of data storage) than storage system memory comprising the main cache. When using a victim cache to store evicted data, the storage system may remap storage system addresses (e.g., LBNs) to victim cache addresses (e.g., page numbers) to properly access data on the victim cache. Typically, the storage system stores remapping data for remapping storage system addresses to victim cache addresses. However, for a large capacity victim cache (e.g., 1 terabyte in size), the amount of remapping data stored by the storage system may become too large to manage efficiently. As such, there is a need for a method and apparatus for remapping addresses on a large capacity victim cache that reduces the storage size needed for the remapping data.

### SUMMARY OF THE INVENTION

Described herein are method and apparatus for remapping addresses on a victim cache used in a storage system. The storage system may store a plurality of data blocks on a plurality of storage devices, each data block having an associated storage system address that indicates the storage location of the data block on a storage device. Each evicted data block stored in the victim cache has an associated storage system address and a victim cache address that indicates the storage location of the evicted data block in the victim cache. Remapping between storage system addresses to victim cache addresses may be performed to properly access requested data blocks in the victim cache. In some embodiments, the victim cache is logically sub-divided into two or more sub-sections, each VC sub-section having an associated remapping data structure storing remapping data for the associated VC sub-section. In these embodiments, by sub-dividing the victim cache into two or more sub-sections and maintaining remapping data in two or more remapping data structures, the overall storage size of the remapping data for the victim cache may be reduced.

The victim cache may comprise a plurality of pages for storing evicted data blocks. In some embodiments, the victim cache may be logically sub-divided into two or more contiguous victim cache sub-sections (referred to as VC sub-sections), each VC sub-section having a sub-section identifier that uniquely identifies the VC sub-section among the two or more VC sub-sections. Each VC sub-section may comprise a plurality of contiguous pages in the victim cache. Each page within a VC sub-section may store a data block that has an associated storage system address, the page having a victim cache address that identifies the location of the page within the VC sub-section. In some embodiments, each VC sub-section may be implemented as a separate and independent log buffer, whereby newly received evicted data is written in chronological order to the next available page in the VC sub-section.

As client access requests (specifying storage system addresses of requested data) are received by the storage system, the storage system may determine whether the requested data is stored in the main cache or victim cache. If so, the storage system may retrieve the requested data from the main cache or victim cache, rather than retrieve the requested data than a disk device (which is slower). To determine whether the victim cache stores requested data, the storage system may use two or more remapping data structures (e.g., stored in storage system memory) that contain information (remapping data) that describe the data blocks currently stored in the victim cache. The remapping data structures may be used to remap received storage system addresses to victim cache addresses that may be used to retrieve requested data from the victim cache.

In some embodiments, each remapping data structure stores remapping data for an assigned/associated VC sub-section, so that each VC sub-section has a corresponding remapping data structure that contains its remapping data. Each remapping data structure may be identified by a data structure identifier that uniquely identifies the remapping data structure among the two or more remapping data structures. Each remapping data structure may comprise a plurality of sets, each set being identified by a set identifier that uniquely identifies the set within the remapping data structure. Each set may comprise a plurality of remapping entries, each remapping entry having remapping data for an evicted data block. The remapping data may include data for remapping the storage system address to a victim cache address for the evicted data block, the victim cache address indicating the location of the page within the corresponding VC sub-section where the evicted data block is stored.

In some embodiments, the storage operating system contains a remapping module/engine for producing and maintaining the two or more remapping data structures and for using the remapping data structures to remap storage system addresses to victim cache addresses. The remapping module may do so by applying a mapping function (e.g., hash function) to a received storage system address (e.g., of a requested data block) to produce a mapping value (e.g., hash value). In some embodiments, the hash value comprises a first sub-portion comprising a data structure identifier and a second sub-portion comprising a set identifier. The data structure identifier is used to identify a particular remapping data structure that contains the remapping data for the received storage system address. The set identifier is used to identify a particular set in the identified remapping data structure, the identified set containing the remapping data for the received storage system address.

As each set comprises a plurality of remapping entries, the entries in the identified set may be examined to determine whether a “matching entry” exists in the identified set, the matching entry having a storage system address that matches the received storage system address. If so, the remapping data in the matching entry is retrieved to remap the received storage system address to a victim cache address (that specifies an address of a page within a VC sub-section corresponding to the identified remapping data structure). The victim cache address is then used to retrieve the requested data block from the corresponding VC sub-section. If a matching entry is not found, the requested data block may be retrieved from a storage device (disk) of the storage system.

By sub-dividing the victim cache into two or more sub-sections and maintaining remapping data in two or more corresponding remapping data structures, the overall storage size of the remapping data for the victim cache may be reduced. This is due to the fact that since the number of page locations of each VC sub-section is smaller than the number of page locations of the entire victim cache, the range of page addresses needed to cover the pages of each VC sub-section is smaller than the range of page addresses needed to cover the entire victim cache. Thus, the number of bits used for the addresses for each VC sub-section may be less than the number of bits used for the addresses for the entire victim cache. The reduced-sized addresses (victim cache addresses) for the VC sub-sections may be stored in the remapping data structures (rather than the larger sized addresses for the entire victim cache), which reduces the amount of remapping data stored in each remapping entry of the remapping data structures. Overall, this may provide substantial storage savings through the remapping data structures.

To further reduce storage size of the remapping data in the remapping data structures, some metadata may be stored to the victim cache itself, rather than in the remapping data structures (which is typically stored in main memory). As described above, a remapping entry for an evicted data block comprises remapping data that includes the storage system address (e.g., LBN) and a victim cache address. Typically an evicted data block may have additional associated metadata (e.g., file block number (FBN) or physical block number (PBN)) and the remapping entry for the evicted data block may typically store the additional metadata for verifying/double checking whether the remapping entry is the correct entry that matches the requested data block. In some embodiments, other than a storage system address and a victim cache address, any additional metadata (e.g., FBN, PBN) is stored to the victim cache. In some embodiments, the additional metadata of an evicted block may be stored to the page in the victim cache that stores the evicted data block.

### BRIEF DESCRIPTION OF THE DRAWINGS

The novel features are set forth in the appended claims. However, for purpose of explanation, several embodiments of the invention are set forth in the following figures.

FIG. 1 is a schematic block diagram of an exemplary storage system environment in which some embodiments operate;

FIG. 2 is a schematic block diagram of an exemplary storage system that may be employed in the storage system environment of FIG. 1;

FIG. 3 is a schematic block diagram of an exemplary storage operating system that may be implemented by the storage system in FIG. 2;

FIG. 4 shows a conceptual diagram of a device driver layer that includes an LLRRM driver;

FIG. 5 shows a conceptual diagram of the storage architecture of a generic erase-unit LLRRM device;

FIG. 6A shows a conceptual diagram of a victim cache sub-divided into two or more VC sub-sections;

FIG. 6B shows a conceptual diagram of a VC sub-section implemented as a log buffer;

FIG. 7 is a conceptual illustration of each log buffer of the victim cache having a corresponding associated remapping data structure;

FIG. 8 shows a conceptual illustration of the contents of a remapping data structure;

FIG. 9 shows a conceptual illustration of the processes performed by the remapping module in using a hash function;

FIG. 10 is a flowchart of a method for sub-dividing a victim cache into multiple sub-sections;

FIG. 11 is a flowchart of a method for storing evicted data blocks from a main cache into a victim cache; and

FIG. 12 is a flowchart of a method for remapping addresses of evicted data blocks stored in a victim cache.

### DETAILED DESCRIPTION

In the following description, numerous details are set forth for purpose of explanation. However, one of ordinary skill in the art will realize that the embodiments described herein may be practiced without the use of these specific details. In other instances, well-known structures and devices are shown in block diagram form in order not to obscure the description with unnecessary detail.

The description that follows is divided into five sections. Section I describes a storage system environment in which some embodiments operate. Section II describes a remapping module for using a victim cache. Section III describes remapping data structures used for storing remapping data for a victim cache. Section IV describes methods for managing remapping data for a victim cache.

### I. Storage System Environment

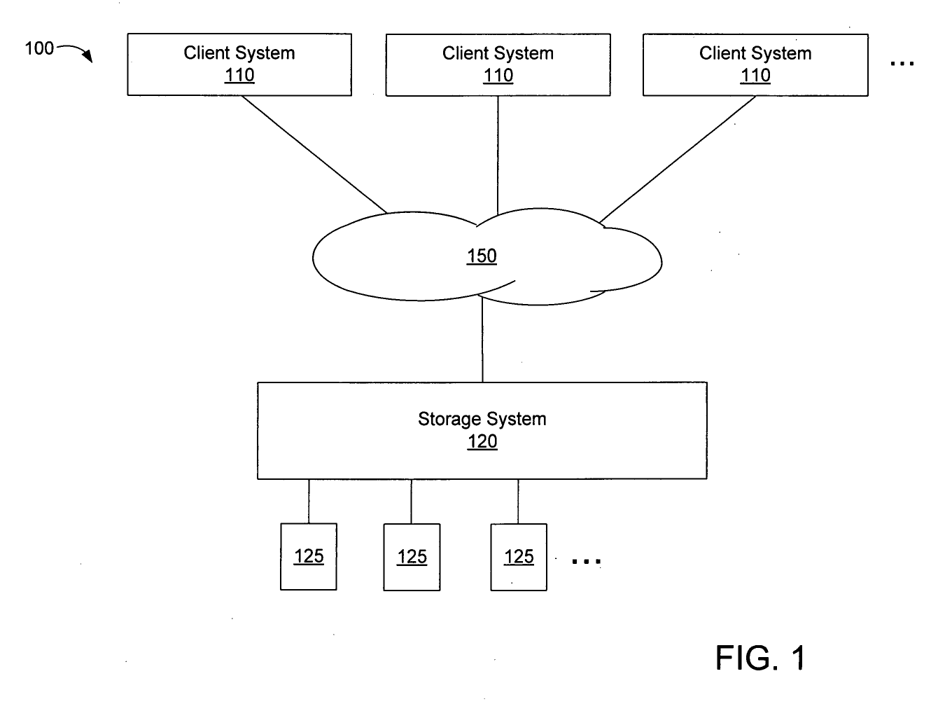

FIG. 1 is a schematic block diagram of an exemplary storage system environment 100 in which some embodiments operate. The environment 100 comprises a one or more client systems 110 and a storage system 120 that are connected via a connection system 150. The storage system 120 may comprise a set of one or more storage devices 125. The connection system 150 may comprise a network, such as a Local Area Network (LAN), Wide Area Network (WAN), metropolitan area network (MAN), the Internet, or any other type of network or communication system between computer systems.

A client system 110 may comprise a computer system that utilizes services of the storage system 120 to store and manage data in the storage devices of the storage system 120. A client system 110 may execute one or more applications that submit access requests for accessing particular data on the storage devices 125 of the storage system 120. Interaction between a client system 110 and the storage system 120 can enable the provision of storage services. That is, client system 110 may request the services of the storage system 120 (e.g., through read or write requests), and the storage system 120 may return the results of the services requested by the client system 110, by exchanging packets over the connection system 150.

The client system 110 may request the services of the storage system by issuing packets using file-based access protocols, such as the Common Internet File System (CIFS) protocol or Network File System (NFS) protocol, over the Transmission Control Protocol/Internet Protocol (TCP/IP) when accessing information in the form of files and directories. Alternatively, the client system 110 may issue packets including block-based access protocols, such as the Fibre Channel Protocol (FCP), or Internet Small Computer System Interface (iSCSI) Storage Area Network (SAN) access, when accessing information in the form of blocks.

The storage system 120 may comprise a computer system that stores data in a set of one or more storage devices 125. A storage device 125 may comprise a writable storage device media, such as magnetic disks, video tape, optical, DVD, magnetic tape, and any other similar media adapted to store information (including data and parity information). For illustrative purposes, the storage device 125 is sometimes described herein as a disk. In other embodiments, the storage device 125 may comprise a solid state memory device (discussed below).

The storage system 120 may implement a file system to logically organize the data as a hierarchical structure of directories and files on each storage device 125. Each file may be implemented as a set of blocks configured to store data, whereas each directory may be implemented as a specially-formatted file in which information about other files and directories are stored. A block of a file may comprise a fixed-sized amount of data that comprises the smallest amount of storage space that may be accessed (read or written) on a storage device 125. The block may vary widely in data size (e.g., 1 byte, 4-kilobytes (KB), 8 KB, etc.).

The storage operating system may assign/associate a unique storage system address (e.g., logical block number (LBN)) for each data block stored in the set of storage devices 125 of the storage system. The unique storage system address for a data block may be used by the storage operating system to locate and access (read/write) the data block. In some embodiments, the unique storage system address is referred to as a logical block number (LBN) or a logical block address (LBA). In other embodiments, the storage system address may be expressed in any variety of forms (e.g., logical volume block number, etc.), as long as the storage system address uniquely identifies an address of a data block.

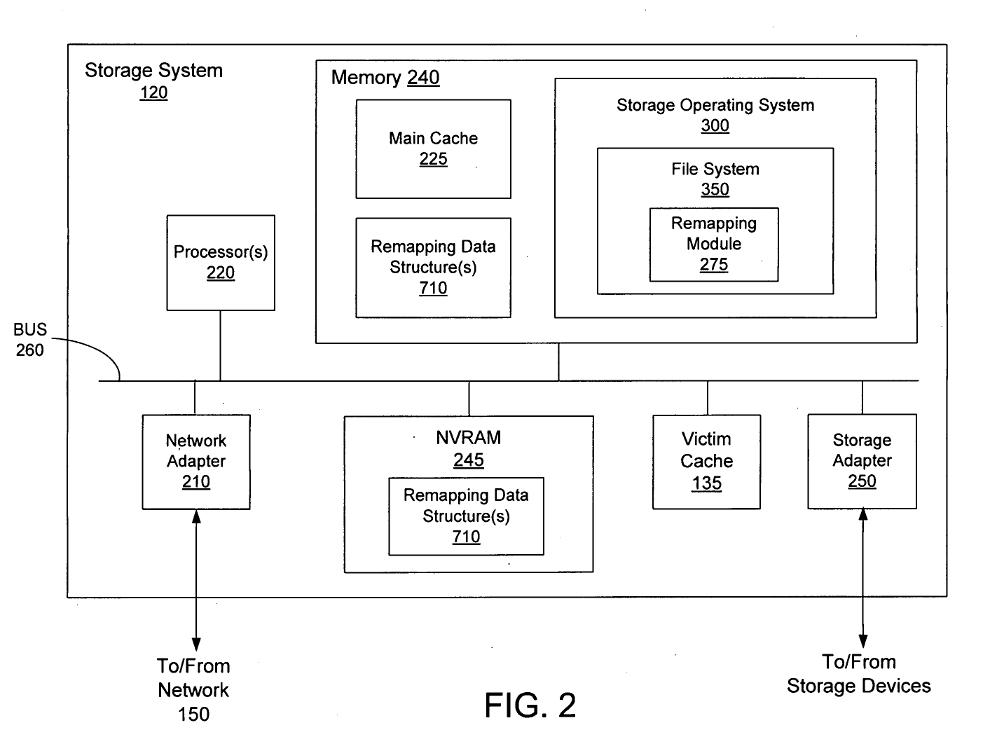

FIG. 2 is a schematic block diagram of an exemplary storage system 120 that may be employed in the storage system environment of FIG. 1. Those skilled in the art will understand that the embodiments described herein may apply to any type of special-purpose computer (e.g., storage system) or general-purpose computer, including a standalone computer, embodied or not embodied as a storage system. To that end, storage system 120 can be broadly, and alternatively, referred to as a computer system. Moreover, the teachings of the embodiments described herein can be adapted to a variety of storage system architectures including, but not limited to, a network-attached storage environment, a storage area network and disk assembly directly-attached to a server computer. The term “storage system” should, therefore, be taken broadly to include such arrangements.

The storage system 120 comprises a network adapter 210, processor(s) 220, a memory 240, a non-volatile random access memory (NVRAM) 245, a victim cache device 135 (“victim cache”), and a storage adapter 250 interconnected by a system bus 260. The network adapter 210 comprises the mechanical, electrical and signaling circuitry needed to connect the storage system 120 to a client system 110 over a computer network 150. The storage system may include one or more network adapters. Each network adapter 210 has a unique IP address and may provide one or more data access ports for client systems 110 to access the storage system 120 (where the network adapter accepts read/write access requests from the client systems 110 in the form of data packets).

The memory 240 comprises storage locations that are addressable by the processor 220 and adapters for storing software program code and data. The memory 240 may comprise a form of random access memory (RAM) that is generally cleared by a power cycle or other reboot operation (e.g., it is a “volatile” memory). In other embodiments, however, the memory 240 may comprise a non-volatile form of memory that does not require power to maintain information. The processor 220 and adapters may, in turn, comprise processing elements and/or logic circuitry configured to execute the software code and manipulate the data stored in the memory 240.

The storage system 120 may also include a NVRAM 245 that may be employed as a backup memory that ensures that the storage system 120 does not “lose” received information, e.g., CIFS and NFS requests, in the event of a system shutdown or other unforeseen problem. The NVRAM 245 is typically a large-volume solid-state memory array having either a back-up battery, or other built-in last-state-retention capabilities, that holds the last state of the memory in the event of any power loss to the array. Therefore, even if an access request stored in memory 240 is lost or erased (e.g., due to a temporary power outage) it still may be recovered from the NVRAM 245. In other embodiments, in place of NVRAM 245, the storage system 120 may include any other type of non-volatile memory (such as flash memory, Magnetic Random Access Memory (MRAM), Phase Change RAM (PRAM), etc.).

The processor 220 executes a storage operating system application 300 of the storage system 120 that functionally organizes the storage system by, inter alia, invoking storage operations in support of a file service implemented by the storage system. In some embodiments, the storage operating system 300 comprises a plurality of software layers/engines (including a file system 350) that are executed by the processor 220. Portions of the storage operating system 300 are typically resident in memory 240. It will be apparent to those skilled in the art, however, that other processing and memory means, including various computer readable media, may be used for storing and executing program instructions pertaining to the storage operating system 300. In some embodiments, a software layer may comprise an engine comprising firmware or software and hardware configured to perform embodiments described herein.

The storage adapter 250 cooperates with the storage operating system 300 executing on the storage system 120 to access data requested by the client system 110. The data may be stored on the storage devices 125 that are attached, via the storage adapter 250, to the storage system 120 or other node of a storage system as defined herein. The storage adapter 250 includes input/output (I/O) interface circuitry that couples to the storage devices 125 over an I/O interconnect arrangement, such as a conventional high-performance, Fibre Channel serial link topology. In response to an access request received from a client system 110, data may be retrieved by the storage adapter 250 and, if necessary, processed by the processor 220 (or the adapter 250 itself) prior to being forwarded over the system bus 260 to the network adapter 210, where the data is formatted into a packet and returned to the client system 110.

In an illustrative embodiment, the storage devices 125 may comprise disks that are arranged into a plurality of volumes, each having a file system associated therewith. In one embodiment, the storage devices 125 comprise disks that are configured into a plurality of RAID (redundant array of independent disks) groups whereby multiple storage devices 125 are combined into a single logical unit (i.e., RAID group). In a typical RAID group, storage devices 125 of the group share or replicate data among the disks which may increase data reliability or performance. The storage devices 125 of a RAID group are configured so that some disks store striped data and at least one disk stores separate parity for the data, in accordance with a preferred RAID-4 configuration. However, other configurations (e.g. RAID-5 having distributed parity across stripes, RAID-DP, etc.) are also contemplated. A single volume typically comprises a plurality of storage devices 125 and may be embodied as a plurality of RAID groups.

In some embodiments, the memory 240 also includes a main cache 225 (i.e., buffer cache). The main cache 225 may be allocated by the storage operating system for use by the file system 350 and have a predetermined storage size. For improved response to received read or write requests, the file system 350 may temporarily store/cache particular data into the main cache 225 for faster access. The storage operating system 300 may employ caching techniques to determine which data to store to the main cache (e.g., such as techniques that predict which data is likely to be requested by future client requests). Since the allocated storage size of the main cache 225 is relatively small, data stored in the main cache is routinely transferred (“evicted”) out of the main cache 225 to make space for new incoming data. Data transferred out of the main cache (referred to as “evicted data”) may be transferred to the victim cache victim cache device 135 for storage.

In some embodiments, the file system 350 includes a victim cache remapping module 275 (“remapping module”) for managing access to the victim cache 135. In some embodiments, the remapping module 275 may comprise a remapping engine comprising firmware or software and hardware configured to perform embodiments described herein. In general, functions of a software module or software layer described herein may be embodied directly in hardware, or embodied as software executed by a processor, or embodied as a combination of the two. The remapping module 275 may be configured for remapping storage system addresses to victim cache addresses for accessing data in the victim cache 135. The remapping module 275 may produce and maintain two or more remapping data structures 710 for storing remapping data for the victim cache 135. The remapping data structures 710 may be stored in memory 240 and/or NVRAM 245 (as shown in FIG. 2), or in any other storage device.

In some embodiments, the victim cache 135 resides in the storage system's internal architecture and is connected with the system bus 260. For example, the victim cache 135 may be a module on a Peripheral Component Interconnect (PCI) or PCI eXtended (PCI-X) card that is connected with the system bus 260. The victim cache 135 may comprise a storage device that is less costly (for a given amount of data storage) than storage system memory 240 comprising the main cache 225.

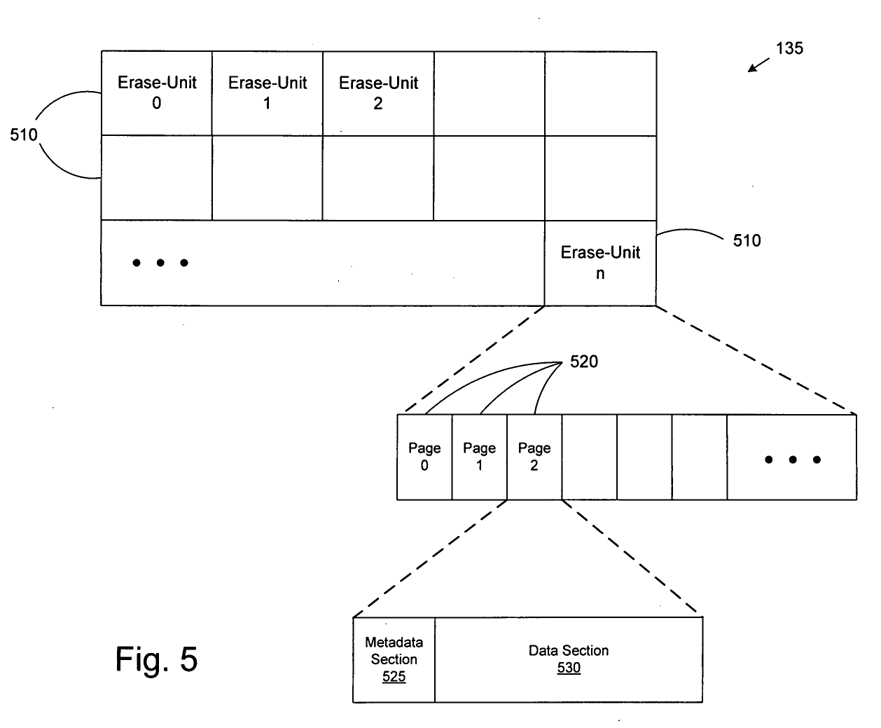

The victim cache 135 may comprise a low-latency random read memory (referred to herein as “LLRRM”) and may thus still provide faster data access than disk devices. In some embodiments, an LLRRM comprises a volatile or non-volatile rewritable computer memory (i.e., a computer memory that does or does not require power to maintain information stored in the computer memory and may be electrically erased and reprogrammed) having lower latency in performing random-read requests relative to disk devices. As known in the art, a disk device comprises mechanical moving components for reading and writing data (such as platters and the read/write head). In some embodiments, a LLRRM comprises a rewritable solid state memory device having no mechanical moving parts for reading and writing data. Some examples of LLRRMs include various form of volatile RAM (e.g., DRAM), flash memory, non-volatile random access memory (NVRAM), Magnetic Random Access Memory (MRAM), Phase Change RAM (PRAM), etc. In some embodiments, an LLRRM comprises an erase-unit memory device (e.g., flash memory), as described below in relation to FIG. 5. In other embodiments, other LLRRM devices are used other than those listed here.

When using a victim cache 135 to store evicted data, the file system 350 may need to keep track of the data stored in the victim cache 135 and be able to remap storage system addresses (e.g., LBNs) to victim cache addresses to properly access data on the victim cache 135. Typically, the file system 350 may do so by producing and managing remapping data. However, for a large capacity victim cache (e.g., 1 terabyte in size), the amount of remapping data stored by the file system 350 may become too large to manage efficiently using conventional remapping methods. Some embodiments used herein reduce the storage size amount of the remapping data.

The organization of a storage operating system 300 for the exemplary storage system 120 is now described briefly. However, it is expressly contemplated that the principles of the embodiments described herein can be implemented using a variety of alternative storage operating system architectures. As discussed above, the term “storage operating system” as used herein with respect to a storage system generally refers to the computer-executable code operable on a storage system and manages data access. In this sense, Data ONTAP® software is an example of such a storage operating system implemented as a microkernel. The storage operating system can also be implemented as an application program operating over a general-purpose operating system, such as UNIX® or Windows®, or as a general-purpose operating system with configurable functionality.

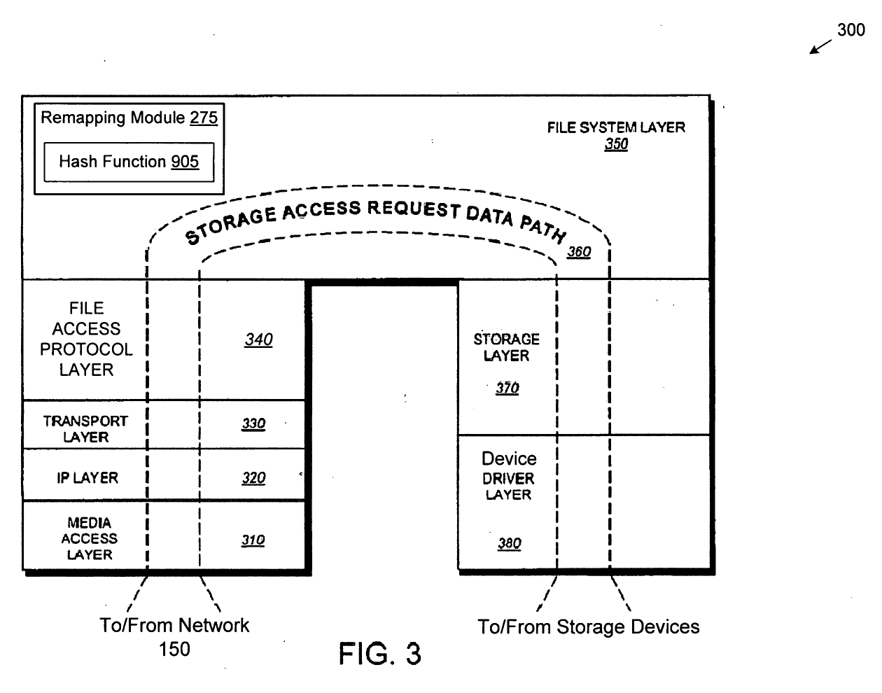

As shown in FIG. 3, the storage operating system 300 comprises a series of software layers/engines that form an integrated protocol software stack. The protocol stack provides data paths 360 for client systems 110 to access data stored on the storage system 120 using file-access protocols. The protocol stack includes a media access layer 310 of network drivers (e.g., an Ethernet driver). The media access layer 310 interfaces with network communication and protocol layers, such as the Internet Protocol (IP) layer 320 and the transport layer 330 (e.g., TCP/UDP protocol). The IP layer 320 may be used to provide one or more data access ports for client systems 110 to access the storage system 120. In some embodiments, the IP layer 320 layer provides a dedicated private port for each of one or more remote-file access protocols implemented by the storage system 120.

A file-access protocol layer 340 provides multi-protocol data access and, for example, may include support for the Hypertext Transfer Protocol (HTTP) protocol, the NFS protocol, and the CIFS protocol. The storage operating system 300 may include support for other protocols, including, but not limited to, the direct access file system (DAFS) protocol, the web-based distributed authoring and versioning (WebDAV) protocol, the Internet small computer system interface (iSCSI) protocol, and so forth. The storage operating system 300 may manage the storage devices 125 using a storage layer 370 that implements a storage protocol (such as a RAID protocol) and a device driver layer 380 that implements a device control protocol (such as small computer system interface (SCSI), integrated drive electronics (IDE), etc.).

Bridging the storage device software layers/engines with the network and file-system protocol layers is a file system layer 350 of the storage operating system 300. In an illustrative embodiment, the file system layer 350 implements a file system having an on-disk format representation that is block-based using, for example, 4 KB data blocks. For each data block, the file system layer 350 may assign/associate a unique storage system address (e.g., a unique LBN) for storing data blocks in the set of storage devices 125. The file system layer 350 also assigns, for each file, a unique inode number and an associated inode. An inode may comprise a data structure used to store information about a file, such as ownership of the file, access permission for the file, size of the file, name of the file, location of the file, etc. Each inode may also contain information regarding the block locations of the file. In some embodiments, the block locations are indicated by LBNs assigned for each block of the file.

In response to receiving a file-access request (specifying a storage system address), the file system generates operations to load (retrieve) the requested data from the storage devices. If the data are not resident in the main cache 225 or the victim cache 135, the file system layer 350 indexes into an inode using the received inode number to access an appropriate entry and retrieve a storage system address (e.g., LBN). The storage system address may then be used by the file system layer 350, storage layer 370, and an appropriate driver of the device driver layer 380 to access the requested storage system address from the storage devices. The requested data may then be loaded in memory 240 for processing by the storage system 120. Upon successful completion of the request, the storage system (and storage operating system) returns a response, e.g., an acknowledgement packet defined by the CIFS specification, to the client system 110 over the network 150.

It should be noted that the “path” 360 through the storage operating system layers described above needed to perform data storage access for the requests received at the storage system may alternatively be implemented in hardware or a combination of hardware and software. That is, in an alternative embodiment, the storage access request path 360 may be implemented as logic circuitry embodied within a field programmable gate array (FPGA) or an application specific integrated circuit (ASIC). This type of hardware implementation may increase the performance of the file service provided by storage system 120 in response to a file system request packet issued by client system 110. Moreover, in a further embodiment, the processing elements of network and storage adapters 210 and 250 may be configured to offload some or all of the packet processing and storage access operations, respectively, from processor 220 to thereby increase the performance of the data access service provided by the storage system.

### II. Remapping Module for Victim Cache

### A. Remapping Module Overview

In response to receiving a client access request (specifying a requested data block stored at a storage system address), the file system 350 may first determine if the requested data block is stored in the main cache 225. If so, the requested data block is retrieved from the main cache 225. If the information is not resident in the main cache 225, the remapping module 275 of the file system 350 determines whether the requested data is stored in the victim cache 135, and if so, retrieves the requested data from the victim cache 135. The remapping module 275 may do so using methods described herein. If the requested data is not resident in the main cache 225 or the victim cache 135, the storage operating system 300 may retrieve the requested data from a storage device 125.

In some embodiments, the remapping module 275 operates in conjunction with the other software layers of the storage operating system 300 to manage access to the victim cache 135. In some embodiments, the remapping module 275 may be pre-included in storage operating system 300 software. In other embodiments, the remapping module 275 may comprise an external auxiliary plug-in type software module that works with the storage operating system 300 to enhance its functions. For example, the device driver layer 380 may be used to help perform the functions of the remapping module 275. In further embodiments, the remapping module 275 may comprise a remapping engine comprising firmware or software and hardware configured to perform embodiments described herein. In general, functions of a software module described herein may be embodied directly in hardware, or embodied as software executed by a processor, or embodied as a combination of the two.

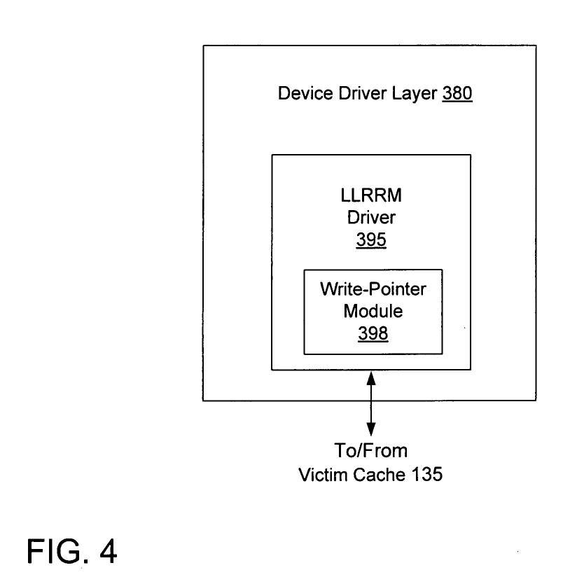

As shown in FIG. 4, the device driver layer 380 may include an LLRRM driver 395 configured for managing the victim cache 135 (e.g., storing data blocks to the victim cache or accessing requested storage locations on the victim cache 135). The LLRRM driver 395 may receive commands (e.g., read page, write page, erase block), victim cache addresses, data size, and any data blocks to be written at the victim cache addresses from the remapping module 275. The LLRRM driver 395 may use the victim cache addresses to locate and access particular storage locations on the victim cache 135 and perform the received commands. For read commands, the LLRRM driver 395 accesses the appropriate data on the victim cache 135 for processing by the storage system 120. Upon successful completion of the request, the storage operating system returns a response to the client system 110 (that submitted the request) over the network 150. In other embodiments, the LLRRM driver 395 may reside on the victim cache 135. In some embodiments, the LLRRM driver 395 also includes a write-pointer module 398 configured to track/record the location of a write pointer within each VC sub-section (as discussed further below).

### B. Overview of Erase-Unit LLRRM Devices

Before discussing the management of the victim cache 135 by the remapping module 275, a brief overview of the storage architecture of an erase-unit LLRRM device is provided. In some embodiments, the victim cache 135 comprises an erase-unit LLRRM device, such as a flash memory. In the embodiments below, the description and terms (e.g., “erase-unit,” “page,” etc.) commonly applied to flash memory devices may be used. However, in other embodiments, the victim cache 135 may comprise any other type of LLRRM device.

FIG. 5 shows a conceptual diagram of the storage architecture of a generic erase-unit LLRRM device that may comprise the victim cache 135. As shown in the example of FIG. 5, the storage space of the LLRRM device may be partitioned/divided into a plurality of erase-units 5 10. The storage space of each erase-unit 510 may also be partitioned/divided into a plurality of pages 520. Although the terms “erase-unit” and “page” are used in some embodiments, these terms should not be construed narrowly. In general, as used herein, an “erase-unit” may indicate a sub-portion of the storage space of an LLRRM device, and a “page” may indicate a sub-portion of the storage space of an erase-unit 510.

Each page 520 of an erase-unit 510 may comprise a data section 530 for storing data and a metadata section 525 used to store metadata relating to the data (such as error correction code, etc.). However, there is typically extra storage space left in each metadata section 525. The data section 530 of each page 520 may be configured for storing a predetermined fixed-sized amount of data that comprises the smallest amount of storage space that may be accessed (read or written) on the LLRRM device. For example, a data section 530 of a page 520 may store a 4 KB data block. Each page 520 also has an associated LLRRM address that uniquely identifies the storage location of the page 520 in the LLRRM device. The LLRRM address of a page may be expressed in different forms. For example, an LLRRM address may comprise an erase-unit number and a page offset number (e.g., erase-unit 2, page offset 3) that uniquely identifies the location of a page 520. As a further example, an LLRRM address may comprise an absolute page number (e.g., page number 235) that uniquely identifies a page offset location from the beginning of the LLRRM device (e.g., where each page is numbered from first page 0 and incrementing to the last page n in the LLRRM device). In other embodiments, LLRRM addresses are expressed in a different form than those listed here.

Data may be written/stored to pages 520 of an erase-unit 510 until the erase-unit is filled. After an erase-unit 510 is “filled” (i.e., after new data is written to the last available page of the erase-unit), new data may later be received for storing in the active erase-unit 510. For conventional erase-unit LLRRM devices, before a previously written page can be overwritten with new data, the page 520 is first be erased before it can be written to again. Also, for conventional erase-unit LLRRM devices, a single page can not be erased and written to with new data. Rather, the entire active erase-unit in which the page resides must typically be erased before the new data can be written to the particular page. As such, it may be advantageous to use a log-based storage scheme for erase-unit LLRRM devices.

C. Sub-Dividing the Victim Cache into Multiple Log Buffers

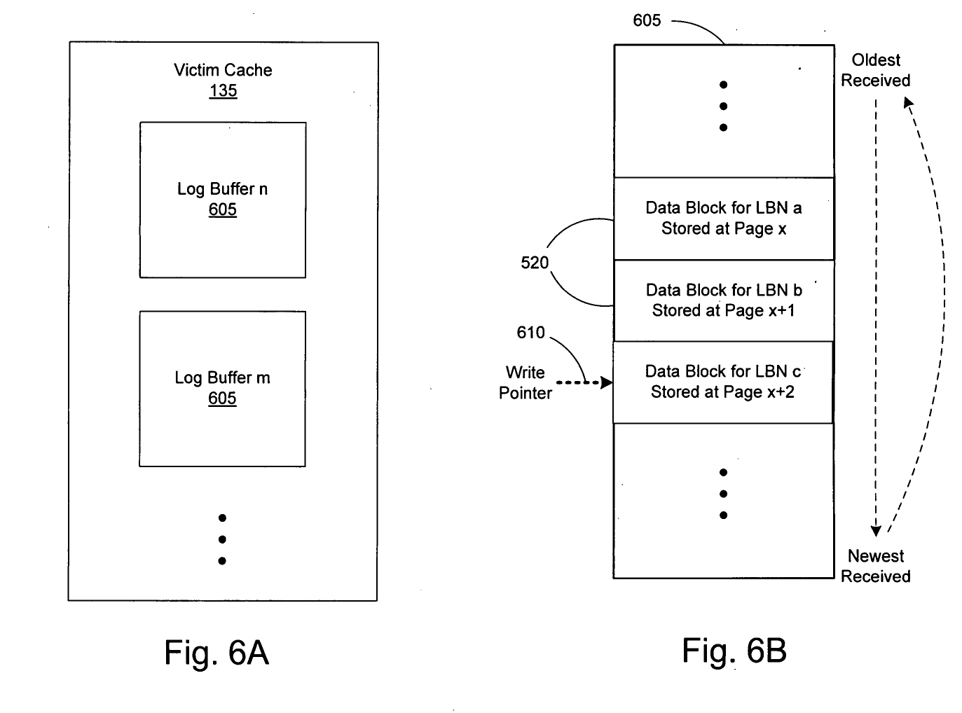

In some embodiments, the remapping layer 275 sub-divides the victim cache 135 into two or more contiguous VC sub-sections, each VC sub-section having an assigned/associated sub-section identifier that uniquely identifies the VC sub-section among the two or more VC sub-sections. Each sub-section may comprise a plurality of contiguous pages (i.e., pages having consecutive address locations in the victim cache 135). As shown in FIG. 6A, in some embodiments, each VC sub-section may be implemented as a separate and independent log buffer 605, whereby data is written to each VC sub-section using a log-based storage scheme. In some embodiments, the victim cache 135 may comprise a single LLRRM device that is sub-divided into multiple log buffers 605, each log buffer 605 having an assigned sub-section identifier (represented as “n” and “m” in FIG. 6A).

FIG. 6B illustrates a log-based storage scheme for a single VC sub-section/log buffer 605. For a VC sub-section implemented as a log buffer 605, newly received evicted data blocks (having associated storage system addresses, such as LBNs) are written in chronological order to the next available page (having the next victim cache address) within the VC sub-section. As shown in the example of FIG. 6B, data blocks may be written starting from the first page to the last page of the VC sub-section/log buffer 605, the oldest received data blocks being stored to the beginning pages and the newest received data blocks being stored to the later pages in the log buffer 605. For example, a received evicted data block (LBN a) may be stored to victim cache address x and the next received evicted data block (LBN b) in time may be stored to the next victim cache address x+1 within the VC sub-section. When a data block is stored to the last page of the log buffer 605, data blocks may begin to be stored starting from the first page of the log buffer 605 again (whereby the older data blocks are overwritten by the newer data blocks).

A write pointer 610 indicates the page location where the next received data block is to be written in the log buffer 605. The write pointer is incremented to the next page location each time after a data block is written to a page. When the write pointer reaches the last page of the VC sub-section, the write pointer starts at the beginning again (i.e., is set to the first page of the VC sub-section at the next increment). The location of the write pointer 610 for each log buffer 605 may be tracked/recorded by the write-pointer module 398 of the LLRRM driver 395 (as shown in FIG. 4), so that the write-pointer module 398 tracks multiple write pointers 610 for the victim cache 135.

Note that since the number and range of page locations of each VC sub-section is smaller than the number and range of page locations of the entire victim cache, the range of page addresses needed to cover the pages of each VC sub-section is smaller than the range of page addresses needed to cover the entire victim cache. In some embodiments, the total range of page locations/addresses of the entire victim cache is 0 through R (R being an integer number). For example, each page in the entire victim cache may have an absolute page number that uniquely identifies the page within the entire victim cache (whereby the absolute page number indicates a page offset location from the beginning of the victim cache, where each page is numbered from first page 0 and incrementing to the last page R). Each VC sub-section may also span a different range of absolute page numbers (e.g., a first VC sub-section spans absolute page numbers 0 through A, a second VC sub-section spans absolute page numbers A+1 through B, a third VC sub-section spans absolute page numbers B+1 through C, and a fourth VC sub-section spans absolute page numbers C+1 through R).

In some embodiments, the range of page locations/addresses of each VC sub-section is 0 through S, where S is an integer number smaller than R. For example, each page in a VC sub-section may have a victim cache address that uniquely identifies the page within the VC sub-section (whereby the victim cache address indicates a page offset location from the beginning of the VC sub-section, where each page is numbered from first page 0 and incrementing to the last page S). In these embodiments, the number of bits used to cover the range of page addresses of a VC sub-section is less than the number of bits used to cover the range of page addresses of the entire victim cache.

In some embodiments, each VC sub-section has a separate and independent address range (victim cache address range) that covers only the range of page locations 0 through S within the VC sub-section (and does not cover the entire range of page locations of the entire victim cache). As such, each page in a VC sub-section may have an associated absolute page number (indicating its location relative to the entire victim cache) and a victim cache address (indicating its location relative to the VC sub-section in which it is located). In some embodiments, for each VC sub-section, a victim cache address of a page in the VC sub-section may indicate the offset location of the page relative to the beginning of the VC sub-section and does not indicate the offset location of the page relative to the beginning of the victim cache.

The bit size for a victim cache address of a page in each VC sub-section may be determined based on the address range of the VC sub-section and not based on the address range of the entire victim cache. In some embodiments, for each page in a VC sub-section, the victim cache address of the page is smaller in bit size than the absolute page number of the page. In these embodiments, the remapping layer may assign victim cache addresses (that span the range from 0 through S) to pages of a VC sub-section, rather than absolute page numbers (that span the range from 0 through R). The remapping layer may store the reduced-sized victim cache addresses in the remapping entries of the remapping data structures to reduce the storage size of each remapping entry. Overall, this may provide substantial storage savings through the remapping data structures.

### III. Remapping Data Structures

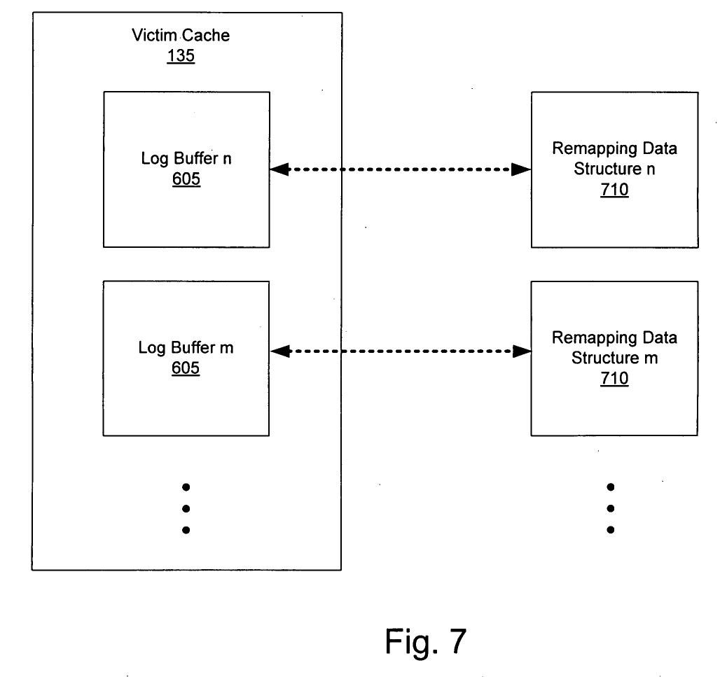

In some embodiments, each VC sub-section/log buffer 605 has a corresponding associated remapping data structure 710 (as assigned by the remapping module 275) that stores remapping data for the VC sub-section and manages data access to the VC sub-section. FIG. 7 is a conceptual illustration of each log buffer 605 of the victim cache 135 having a corresponding associated remapping data structure 710. Each remapping data structure may have a data structure identifier that uniquely identifies the remapping data structure among the two or more remapping data structures (represented as “n” and “m” in FIG. 7). In some embodiments, a remapping data structure may have an assigned data structure identifier that is the same as the sub-section identifier for its corresponding VC sub-section/log buffer 605. As shown in the example of FIG. 7, each corresponding remapping data structure and log buffer 605 pair have the same assigned identifiers (shown as “n” and “m” in FIG. 7). In other embodiments, corresponding remapping data structure and log buffer 605 pairs may have different assigned identifiers.

In some embodiments, the victim cache is sub-divided into 2̂n sub-sections (log buffers 605), n being an integer greater than or equal to 1, whereby 2̂n remapping data structures are produced and maintained for the victim cache. For example, the victim cache may be sub-divided into 2, 4, 8, or 16 sub-sections (where n=1, 2, 3, or 4, respectively), whereby 2, 4, 8, or 16 remapping data structures, respectively, are produced and maintained for the victim cache. Note that the more sub-sections (log buffers 605) that the victim cache is sub-divided into, the smaller the victim cache address range needed for each VC sub-section and the fewer bits needed for each victim cache address stored in the remapping data structures, thus further reducing the storage size needed for the remapping data structures.

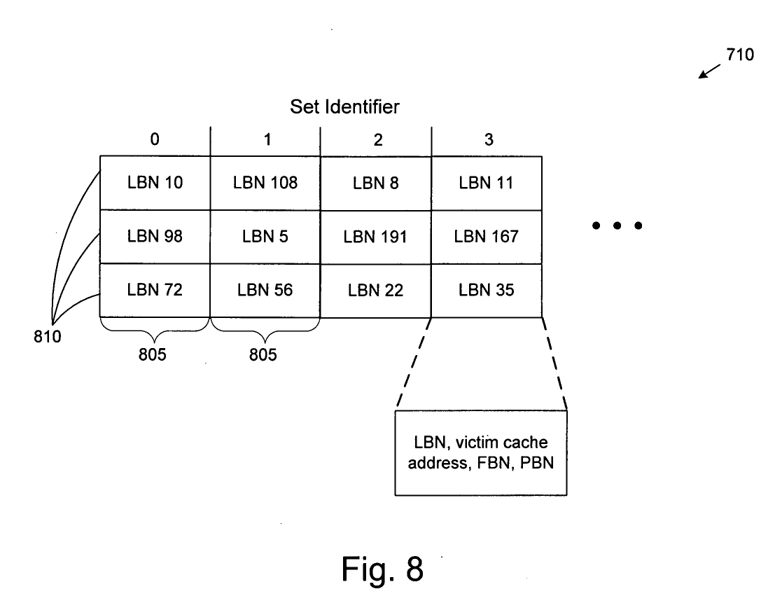

FIG. 8 shows a conceptual illustration of the contents of an exemplary remapping data structure 710. As used herein, a remapping data structure 710 may comprise any container or object for organizing and storing remapping data (such as a table, file, etc.). The remapping data structure 710 may be stored in memory 240 (as shown in FIG. 2) or stored in a non-volatile memory device (such as NVRAM 245). As used in the below description and figures, a storage system address may be represented by “LBN,” but in other embodiments, a storage system address may be represented in a different form. Likewise, a victim cache address may be represented by a page location offset from the beginning of a VC sub-section, but in other embodiments, a victim cache address may be represented in a different form.

A remapping data structure 710 may comprise a plurality of sets 805, each set 805 being identified by an associated set identifier (e.g., 0, 1, 2, 3, etc.) that uniquely identifies the set within the remapping data structure in which it resides. Each set 805 may comprise a plurality of remapping entries 810, each remapping entry 810 comprising remapping data for remapping a single storage system address to a single victim cache address for an evicted data block. In the example of FIG. 8, each set contains 3 remapping entries. However, the sets 805 may be configured to contain two or more remapping entries 810 for each set 805. A higher number of remapping entries 810 per each set 805 will reduce the number of “collisions.” A collision occurs when an old storage system address (and old remapping data) stored in an entry 810 may be overwritten by a new storage system address (and new remapping data) when no further free entries are available in the set 805. However, a higher number of remapping entries 810 per each set 805 will also increase the storage size of the remapping data structure 710.

The remapping data of a remapping entry 810 for an evicted data block may include the associated storage system address (e.g., LBN) and a victim cache address of the evicted data block. In some embodiments, the victim cache address specifies an address of a page within the corresponding VC sub-section where the evicted data block is stored. Note that the range of victim cache addresses stored in the remapping data structure 710 (and the corresponding VC sub-section) may be within the range 0 through S. However, the storage system addresses (LBNs) may be random or pseudo-random since the storage system addresses included in a particular remapping data structure 710 is determined by a mapping function (e.g., hash function), as discussed below.

Typically an evicted data block may have additional associated metadata and the remapping entry for the evicted data block may typically store the additional metadata for verifying/double checking whether the remapping entry is the correct entry that matches the requested data block. Such additional metadata may include a file block number (FBN) or physical block number (PBN). In some embodiments, other than a storage system address and a victim cache address, any additional metadata (e.g., FBN, PBN) of the evicted data block is stored to the victim cache, rather than the remapping data structures. In some embodiments, the additional metadata of an evicted block may be stored to the metadata section 525 (as shown in FIG. 5) of the page 520 that stores the evicted data block, whereby the evicted data block is stored in the data section 530 of the page 520. By doing so, the storage size of the remapping data in the remapping data structures is further reduced.

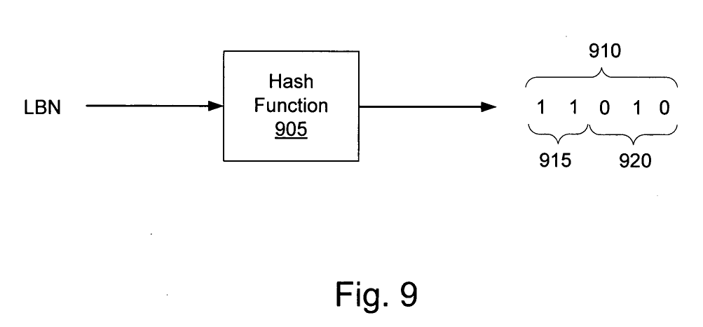

The remapping module 275 may use a mapping function to determine which VC sub-section will store a received evicted data block and which remapping data structures 710 will store the remapping entry for the received evicted data block. In some embodiments, the mapping function may receive an input key value (e.g., storage system address) and map the input key value to a mapping value. In some embodiments, the mapping function may comprise a hash function 905 (as shown in FIG. 3). The remapping module 275 may determine such based on the storage system address of the received evicted data block. As such, a hash function 905 should be chosen that evenly distributes the storage system addresses through the remapping data structures 710 and VC sub-sections. FIG. 9 shows a conceptual illustration of the processes performed by the remapping module 275 in using the hash function 905. In the embodiments described below, a mapping function may be described as a hash function and a mapping value may be described as a hash value. However, in other embodiments, other mapping functions and mapping values may be used other than hash functions and hash values.

As shown in FIG. 9, the remapping module 275 may apply the hash function 905 to a storage system address (e.g., LBN) of a received evicted data block to produce a hash value 910. In some embodiments, the hash value 910 comprises a first sub-portion 915 comprising a data structure identifier and a second sub-portion 920 comprising a set identifier. The data structure identifier 915 may be used to identify a particular remapping data structure 710 (among the two or more remapping data structures 710) that is to contain the remapping entry for the received evicted data block. The first sub-portion 915 may also comprise a sub-section identifier that may be used to identify a particular VC sub-section/log buffer 605 (among the two or more VC sub-sections) that is to store the received evicted data block. The set identifier 920 may be used to identify a particular set 805 (among the plurality of sets within the identified remapping data structure 710) that is to contain the remapping data for the received evicted data block in a remapping entry 810.

In the example of FIG. 9, the hash value 910 is a binary number, whereby the first sub-portion 915 comprises 2 bits and the second sub-portion 920 comprises 3 bits. In this example, since 2 bits may uniquely identify up to four sub-section identifiers and/or four data structure identifiers (e.g., 0 through 3), the victim cache 135 may be sub-divided into 4 VC sub-sections and 4 remapping data structures may be produced and maintained for the victim cache 135. In this example, since 3 bits may uniquely identify up to 8 set identifiers (e.g., 0 through 7), each remapping data structure may comprise 8 sets 805. In other embodiments, the first sub-portion 915 and second sub-portion 920 comprises other numbers of bits other than 2 and 3, respectively. In the example of FIG. 9, the first sub-portion 915 is equal to “11” (indicating sub-section and data structure number 3) and the second sub-portion 920 is equal to “010” (indicating set number 2 in data structure number 3).

In some embodiments, the first sub-portion 915 and second sub-portion 920 may each comprise consecutive bits of the hash value 910. For example, as shown in FIG. 9, the first sub-portion 915 comprises the 2 consecutive highest bits of the hash value 910 and the second sub-portion 920 comprises the 3 consecutive lowest bits of the hash value 910. In other embodiments, however, the first sub-portion 915 and second sub-portion 920 may each comprise non-consecutive bits of the hash value 910. For example, the first sub-portion 915 comprise the highest and lowest bits of the hash value 910 and the second sub-portion 920 may comprise the remaining middle bits of the hash value 910, or vice versa. In general, the first sub-portion 915 and second sub-portion 920 may each comprise any combination of predetermined bits of the hash value 910.

### IV. Methods for Managing Remapping Data for a Victim Cache

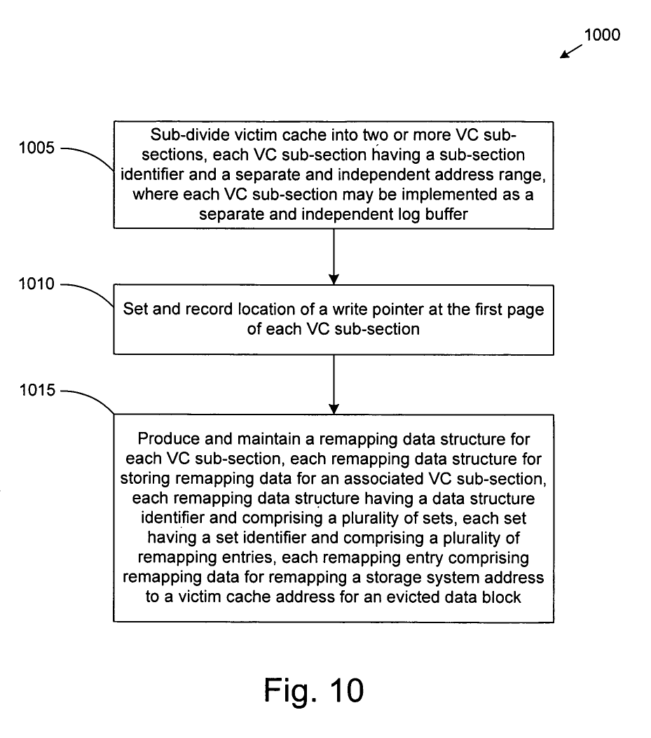

FIG. 10 is a flowchart of a method 1000 for sub-dividing a victim cache (comprising a plurality of pages) into multiple sub-sections. In some embodiments, some of the steps of the method 1000 are implemented by software or hardware. In some embodiments, some of the steps of method 1000 are performed by the remapping module 275 in conjunction with the device driver layer 380. The order and number of steps of the method 1000 are for illustrative purposes only and, in other embodiments, a different order and/or number of steps are used.

The method 1000 begins by logically sub-dividing (at step 1005) the victim cache 135 into two or more VC sub-sections, each VC sub-section having a sub-section identifier that uniquely identifies the VC sub-section. In some embodiments, the victim cache is sub-divided into 2̂n VC sub-sections, n being an integer. The range of page locations/addresses of each VC sub-section may span from 0 through S, whereby each page in a VC sub-section may have a victim cache address that uniquely identifies the page within the VC sub-section. As such, each VC sub-section may have a separate and independent address range (victim cache address range) that covers the range of page locations 0 through S. In some embodiments, each VC sub-section may be implemented as a separate and independent log buffer 605. The method then sets and records (at step 1010) a location of a write pointer at the first page of each VC sub-section.

The method then produces and maintains (at step 1015) a remapping data structure 710 for each VC sub-section, each remapping data structure being assigned/associated with a particular corresponding VC sub-section. A remapping data structure 710 may store remapping data for its corresponding VC sub-section and be used to manage access to the corresponding VC sub-section. Each remapping data structure may have a data structure identifier that uniquely identifies the remapping data structure (that may be equal to the sub-section identifier of its corresponding VC sub-section). Each remapping data structure 710 may comprise a plurality of sets 805, each set 805 being identified by an associated set identifier (e.g., 0, 1, 2, 3, etc.). Each set 805 may comprise a plurality of remapping entries 810, each remapping entry 810 comprising remapping data for remapping a single storage system address to a single victim cache address. The method 1000 then ends.

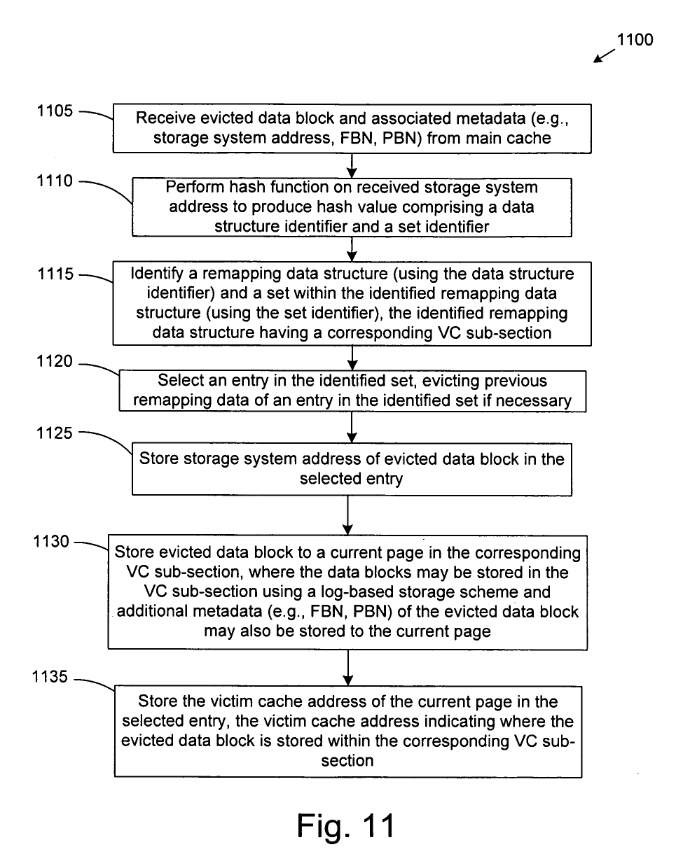

FIG. 11 is a flowchart of a method 1100 for storing evicted data blocks from a main cache 225 into a victim cache 135 and producing remapping data for the evicted data blocks. In some embodiments, some of the steps of the method 1100 are implemented by software or hardware. In some embodiments, some of the steps of method 1100 are performed by the remapping module 275 in conjunction with the device driver layer 380. The order and number of steps of the method 1100 are for illustrative purposes only and, in other embodiments, a different order and/or number of steps are used.

The method 1100 begins when an evicted data block and associated metadata is received (at step 1105) from the main cache 225. The associated metadata may include, for example, an associated storage system address (e.g., LBN), a file block number (FBN), and/or a physical block number (PBN). The method 1100 then performs (at step 1110) a hash function 905 on the received storage system address (LBN) to produce a hash value 910, the hash value comprising a first sub-portion 915 comprising a data structure identifier and a second sub-portion 920 comprising a set identifier.

The method identifies (at step 1115) a remapping data structure 710 (using the data structure identifier) and a set 805 within the identified remapping data structure (using the set identifier). The identified remapping data structure may have a corresponding VC sub-section in the victim cache 135 (referred to as the “identified VC sub-section”) having a sub-section identifier equal to the data structure identifier. The method 1100 then selects (at step 1120) an entry 810 in the identified set 805 in the identified remapping data structure 710. If no open entries are available in the identified set, the method 1100 may evict/delete old remapping data of an entry in the identified set if necessary (e.g., the oldest accessed entry). The method 1100 then stores (at step 1125) the storage system address (e.g., LBN) associated with the evicted data block in the selected entry 810 of the identified set 805.

The method 1100 then stores (at step 1130) the evicted data block to a current page 520 in the corresponding identified VC sub-section in the victim cache 135. In some embodiments, the method 1100 stores data blocks to each VC sub-section using a log-based storage scheme. In some embodiments, the method also stores metadata (e.g., FBN, PBN) associated with the evicted data block to the current page 520. In some embodiments, other than a storage system address and a victim cache address, any additional metadata (e.g., FBN, PBN) of the evicted data block is stored to the current page of the victim cache 135.

For example, the method 1100 may perform step 1130 by sending the evicted data block, the associated metadata (e.g., FBN, PBN), and the corresponding sub-section identifier (which may be equal to the data structure identifier) to the device driver layer 380. The device driver layer 380 may then select a next available page 520 (the current page) in the corresponding VC sub-section to write to (e.g., selected using the current address location of the write pointer in the corresponding VC sub-section). The device driver layer 380 may then store the evicted data block to the data section 530 of the current page 520 and store the associated metadata (e.g., FBN, PBN) to the metadata section 525 of the current page 520. The device driver layer 380 may then increment the address location of the write pointer in the corresponding VC sub-section after each write operation to a page 520 in the corresponding VC sub-section.

The method 1100 then stores (at step 1135) the victim cache address of the evicted data block in the selected entry 810, the victim cache address indicating where the evicted data block is stored within the corresponding VC sub-section. The victim cache address may be equal to the current address location of the write pointer in the corresponding VC sub-section. The method 1100 may be repeated for each received evicted data block.

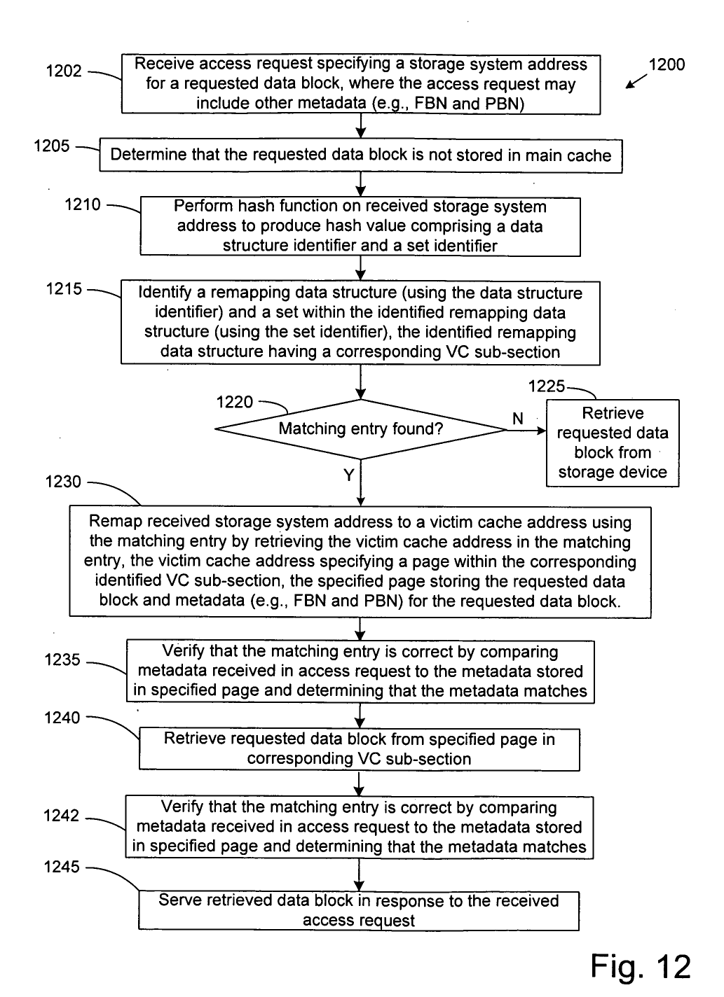

FIG. 12 is a flowchart of a method 1200 for remapping addresses of evicted data blocks stored in a victim cache 135 when receiving read requests for the evicted data blocks. In some embodiments, some of the steps of the method 1200 are implemented by software or hardware. In some embodiments, some of the steps of method 1200 are performed by the remapping module 275 in conjunction with the file system 350 and the device driver layer 380. The order and number of steps of the method 1200 are for illustrative purposes only and, in other embodiments, a different order and/or number of steps are used.

The method 1200 begins when an access request (e.g., read or write request) is received (at step 1202), the access request specifying a storage system address (e.g., LBN) for accessing/retrieving particular data (referred to as the requested data block). The access request may further include other metadata (e.g., FBN and PBN). The method 1200 may determine (at step 1205) that the requested data block is not stored in the main cache 225 using methods known in the art. As such, in steps 1210 through 1220, the method determines whether the requested data block is stored in the victim cache 135.

The method 1200 performs (at step 1210) a hash function 905 on the received storage system address (LBN) to produce a hash value 910, the hash value comprising a first sub-portion 915 comprising a data structure identifier and a second sub-portion 920 comprising a set identifier. The method 1200 identifies (at step 1215) a remapping data structure 710 (using the data structure identifier) and a set 805 within the identified remapping data structure (using the set identifier). The identified remapping data structure may have a corresponding VC sub-section in the victim cache 135 (referred to as the “identified VC sub-section”) having a sub-section identifier equal to the data structure identifier.

The method 1200 then determines (at step 1220) whether there is a matching remapping entry 810 in the identified set 805 in the identified remapping data structure 710, the matching entry 810 having a storage system address that matches the received storage system address (and thereby contains remapping data for the received storage system address). If the method 1200 determines (at step 1220—No) that there is no matching entry in the identified set 805, the method 1200 retrieves (at step 1225) the requested data block from the set of storage devices 125 and the method 1200 ends.

If the method 1200 determines (at step 1220—Yes) that there is a matching entry in the identified set 805, the method 1200 remaps (at step 1230) the received storage system address to a victim cache address using the matching entry (by retrieving the victim cache address stored in the matching entry 810). The victim cache address specifies a page 520 within the corresponding identified VC sub-section, the specified page comprising a data section 530 that stores the requested data block and a metadata section 525 that stores metadata (e.g., FBN and PBN) for the requested data block. In some embodiments, as an optional step, the method 1200 may verify (at step 1235) that the matching entry is the correct entry containing the remapping data for the requested data block. The method may do so by comparing the metadata (e.g., FBN and PBN) received in the access request to the metadata stored in the metadata section 525 of the specified page and determining that the metadata matches.

The method 1200 then retrieves (at step 1240) the requested data block from the specified page in the corresponding VC sub-section. The method 1200 may do so by sending the victim cache address and the corresponding sub-section identifier (which may be equal to the data structure identifier) to the device driver layer 380, which then retrieves the requested data block from the page (specified by the victim cache address) in the corresponding VC sub-section (specified by the sub-section identifier). Note that the method 1200 may perform the metadata verification (at step 1235) before or after retrieving (at step 1240) the requested data block (as shown in optional step 1242 that is performed after step 1240). The method then serves (at step 1245) the retrieved data block in response to the received access request. The method 1200 may be repeated for each received access request.

Some embodiments may be conveniently implemented using a conventional general purpose or a specialized digital computer or microprocessor programmed according to the teachings of the present disclosure, as will be apparent to those skilled in the computer art. Appropriate software coding may readily be prepared by skilled programmers based on the teachings of the present disclosure, as will be apparent to those skilled in the software art. Some embodiments may also be implemented by the preparation of application-specific integrated circuits or by interconnecting an appropriate network of conventional component circuits, as will be readily apparent to those skilled in the art.

Some embodiments include a computer program product which is a storage medium (media) having instructions stored thereon/in which may be used to control, or cause, a computer to perform any of the processes of an embodiment. The storage medium may include without limitation any type of disk including floppy disks, mini disks (MD's), optical disks, DVDs, CD-ROMs, micro-drives, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Stored on any one of the computer readable medium (media), some embodiments include software for controlling both the hardware of the general purpose/specialized computer or microprocessor, and for enabling the computer or microprocessor to interact with a human user or other mechanism utilizing the results of an embodiment. Such software may include without limitation device drivers, operating systems, and user applications. Ultimately, such computer readable media further includes software for performing some embodiments, as described above. Included in the programming (software) of the general/specialized computer or microprocessor are software modules for implementing the teachings of some embodiments.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the embodiments described herein.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The techniques or steps of a method or algorithm described in connection with the embodiments disclosed herein may be embodied directly in hardware, in software executed by a processor, or in a combination of the two. In some embodiments, a software module or software layer may comprise an engine comprising firmware or software and hardware configured to perform embodiments described herein. In general, functions of a software module or software layer described herein may be embodied directly in hardware, or embodied as software executed by a processor, or embodied as a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user device. In the alternative, the processor and the storage medium may reside as discrete components in a user device.

While the embodiments described herein have been described with reference to numerous specific details, one of ordinary skill in the art will recognize that the embodiments can be embodied in other specific forms without departing from the spirit of the embodiments. Thus, one of ordinary skill in the art would understand that the embodiments described herein are not to be limited by the foregoing illustrative details, but rather are to be defined by the appended claims.

We claim:

1. A storage system for storing data blocks, the storage system comprising:
a victim cache for storing data blocks evicted from a main cache, each evicted data block having an associated storage system address, the victim cache being sub-divided into at least two sub-sections, each sub-section comprising a plurality of pages, each page storing a data block and having a victim cache address that specifies the location of the page within the sub-section;
at least two data structures, wherein each data structure stores remapping data for an associated sub-section and comprises a plurality of sets, wherein each set comprises a plurality of entries, each entry comprising remapping data for remapping a storage system address to a victim cache address for an evicted data block;
a storage operating system configured for remapping a received storage system address to a victim cache address by:
performing a mapping function on the received storage system address to produce a mapping value that identifies a set within a data structure;
in the identified set, determining a matching entry comprising a storage system address that matches the received storage system address; and
retrieving a victim cache address from the matching entry for remapping the received storage system address to the retrieved victim cache address.

2. The storage system of claim 1, wherein:
each data structure is identified by a data structure identifier;
each set is identified by a set identifier;
the mapping value comprises a first sub-portion comprising a data structure identifier that identifies a data structure among the at least two data structures and a second sub-portion comprising a set identifier that identifies a set among the plurality of sets within the identified data structure.

3. The storage system of claim 1, wherein the storage operating system is further configured for:
prior to remapping the received storage system address, receiving an access request for a requested data block having the received storage system address; and
after remapping the received storage system address, retrieving the requested data block from a page specified by the retrieved victim cache address, the specified page being in the sub-section associated with identified data structure.

4. The storage system of claim 3, wherein:
the received access request comprises metadata for the requested data block;
each page stores a data block in a data section and metadata for the data block in a metadata section; and
the storage operating system is further configured for verifying that the metadata in the access request matches the metadata stored in the metadata section of the specified page.

5. The storage system of claim 1, wherein each sub-section is implemented as a separate and independent log buffer, whereby evicted data blocks received by the log buffer are stored in chronological order to a next available page within the log buffer.

6. The storage system of claim 1, wherein:
each sub-section comprises a separate and independent address range;
a victim cache address of a page in each sub-section indicates the offset location of the page relative to the beginning of the sub-section and not relative to the beginning of the victim cache; and
a bit size for a victim cache address of a page in a sub-section is determined by the address range of the sub-section and not the address range of the entire victim cache.

7. The storage system of claim 1, wherein the victim cache is sub-divided into 2̂n sub-sections, n being an integer greater than or equal to 1, whereby the at least two data structures comprises 2̂n data structures.

8. The storage system of claim 1, wherein the victim cache comprises a single low-latency random read memory (LLRRM) device having lower latency in performing random read requests relative to disk devices.

9. A method for storing data blocks in a storage system, the method comprising:
storing data blocks evicted from a main cache in a victim cache, each evicted data block having an associated storage system address, the victim cache being sub-divided into at least two sub-sections, each sub-section comprising a plurality of pages, each page storing a data block and having a victim cache address that specifies the location of the page within the sub-section;
providing at least two data structures, wherein each data structure stores remapping data for an associated sub-section and comprises a plurality of sets, wherein each set comprises a plurality of entries, each entry comprising remapping data for remapping a storage system address to a victim cache address for an evicted data block;
remapping a received storage system address to a victim cache address by:
performing a mapping function on the received storage system address to produce a mapping value that identifies a set within a data structure;
in the identified set, determining a matching entry comprising a storage system address that matches the received storage system address; and
retrieving a victim cache address from the matching entry for remapping the received storage system address to the retrieved victim cache address.

10. The method of claim 9, wherein:
each data structure is identified by a data structure identifier;
each set is identified by a set identifier;
the mapping value comprises a first sub-portion comprising a data structure identifier that identifies a data structure among the at least two data structures and a second sub-portion comprising a set identifier that identifies a set among the plurality of sets within the identified data structure.

11. The method of claim 9, further comprising:
prior to remapping the received storage system address, receiving an access request for a requested data block having the received storage system address; and
after remapping the received storage system address, retrieving the requested data block from a page specified by the retrieved victim cache address, the specified page being in the sub-section associated with identified data structure.

12. The method of claim 11, wherein the received access request comprises metadata for the requested data block and each page stores a data block in a data section and metadata for the data block in a metadata section, the method further comprising:
verifying that the metadata in the access request matches the metadata stored in the metadata section of the specified page.

13. The method of claim 9, wherein each sub-section is implemented as a separate and independent log buffer, whereby evicted data blocks received by the log buffer are stored in chronological order to a next available page within the log buffer.

14. The method of claim 9, wherein:
each sub-section comprises a separate and independent address range;
a victim cache address of a page in each sub-section indicates the offset location of the page relative to the beginning of the sub-section and not relative to the beginning of the victim cache; and
a bit size for a victim cache address of a page in a sub-section is determined by the address range of the sub-section and not the address range of the entire victim cache.

15. The method of claim 9, wherein the victim cache is sub-divided into 2̂n sub-sections, n being an integer greater than or equal to 1, whereby the at least two data structures comprises 2̂n data structures.

16. The method of claim 9, wherein the victim cache comprises a single low-latency random read memory (LLRRM) device having lower latency in performing random read requests relative to disk devices.

17. A storage system for storing data blocks, the storage system comprising:
a victim cache for storing data blocks evicted from a main cache, each evicted data block having an associated storage system address, the victim cache being sub-divided into at least two sub-sections, each sub-section comprising a plurality of pages, each page storing a data block and having a victim cache address that specifies the location of the page within the sub-section;
at least two data structures, wherein each data structure stores remapping data for an associated sub-section and comprises a plurality of sets, wherein each set comprises a plurality of entries, each entry comprising remapping data for remapping a storage system address to a victim cache address for an evicted data block;
a storage operating system configured for storing a received evicted data block to the victim cache by:
performing a mapping function on a storage system address associated with the received evicted data block to produce a mapping value that identifies a data structure and a set within the identified data structure;
storing the associated storage system address in a selected entry in the identified set;
storing the evicted data block to a current page in the sub-section associated with the identified data structure; and
storing the victim cache address of current page in the selected entry, the victim cache address indicating where the evicted data block is stored within the associated sub-section.

18. The storage system of claim 17, wherein:
each data structure is identified by a data structure identifier;
each set is identified by a set identifier;
the mapping value comprises a first sub-portion comprising a data structure identifier that identifies a data structure among the at least two data structures and a second sub-portion comprising a set identifier that identifies a set among the plurality of sets within the identified data structure.

19. The storage system of claim 17, wherein:
the received evicted data block has associated metadata; and
the storage operating system is further configured for storing the associated metadata in the current page, whereby only the associated storage system address and the victim cache address of the received evicted data block is stored in the selected entry.

20. The storage system of claim 17, wherein each sub-section is implemented as a separate and independent log buffer, whereby evicted data blocks received by the log buffer are stored in chronological order to a next available page within the log buffer.

21. The storage system of claim 17, wherein:
each sub-section comprises a separate and independent address range;
a victim cache address of a page in each sub-section indicates the offset location of the page relative to the beginning of the sub-section and not relative to the beginning of the victim cache; and
a bit size for a victim cache address of a page in a sub-section is determined by the address range of the sub-section and not the address range of the entire victim cache.

22. A method for storing data blocks in a storage system, the method comprising:
storing data blocks evicted from a main cache in a victim cache, each evicted data block having an associated storage system address, the victim cache being sub-divided into at least two sub-sections, each sub-section comprising a plurality of pages, each page storing a data block and having a victim cache address that specifies the location of the page within the sub-section;
providing at least two data structures, wherein each data structure stores remapping data for an associated sub-section and comprises a plurality of sets, wherein each set comprises a plurality of entries, each entry comprising remapping data for remapping a storage system address to a victim cache address for an evicted data block;
storing a received evicted data block to the victim cache by:
performing a mapping function on a storage system address associated with the received evicted data block to produce a mapping value that identifies a data structure and a set within the identified data structure;
storing the associated storage system address in a selected entry in the identified set;
storing the evicted data block to a current page in the sub-section associated with the identified data structure; and
storing the victim cache address of current page in the selected entry, the victim cache address indicating where the evicted data block is stored within the associated sub-section.

23. The method of claim 22, wherein:
each data structure is identified by a data structure identifier;
each set is identified by a set identifier;
the mapping value comprises a first sub-portion comprising a data structure identifier that identifies a data structure among the at least two data structures and a second sub-portion comprising a set identifier that identifies a set among the plurality of sets within the identified data structure.

24. The method of claim 22, wherein the received evicted data block has associated metadata, the method further comprising:
storing the associated metadata in the current page, whereby only the associated storage system address and the victim cache address of the received evicted data block is stored in the selected entry.

25. The method of claim 22, wherein each sub-section is implemented as a separate and independent log buffer, whereby evicted data blocks received by the log buffer are stored in chronological order to a next available page within the log buffer.

26. The method of claim 22, wherein:
each sub-section comprises a separate and independent address range;
a victim cache address of a page in each sub-section indicates the offset location of the page relative to the beginning of the sub-section and not relative to the beginning of the victim cache; and
a bit size for a victim cache address of a page in a sub-section is determined by the address range of the sub-section and not the address range of the entire victim cache.
